(19) United States
(12) Patent Application Publication
(10) Pub. No.: US 2011/0158707 A1
(43) Pub. Date: Jun. 30, 2011

(54) RESTRICTING BLADE AND DEVELOPING DEVICE

(75) Inventor: Shinichi Agata, Suntou-gun (JP)

(73) Assignee: CANON KABUSHIKI KAISHA, Tokyo (JP)

(21) Appl. No.: 12/950,000

(22) Filed: Nov. 19, 2010

(30) Foreign Application Priority Data
Dec. 24, 2009 (JP) 2009-292604

(51) Int. Cl. G03G 15/08

(52) U.S. Cl. 399/284

(57) ABSTRACT

A restricting blade includes: a metallic plate subjected to punching; a contact surface perpendicular to a thickness direction of the metallic plate, the surface being positioned upstream in a punch direction; an end surface of the metallic plate, formed by the punching, the surface being positioned at the metallic plate upstream in a rotational direction of the developing roller; and a coating layer formed in such a manner as to cover a part of a surface positioned opposite to the contact surface in the thickness direction of the metallic plate and the end surface with a resin or an elastomer.

### BACKGROUND OF THE INVENTION

1. Field of the Invention

The present invention relates to a restricting blade for restricting the thickness of a developer agent staying on a developing roller, and a developing device using the same.

2. Description of the Related Art

As a developing device for supplying a developer agent onto an image carrier has been conventionally known a developing device comprising a developing roller and a restricting blade for restricting the thickness of a developer agent staying on the developing roller. In more recent years, a restricting blade obtained by punching a metallic plate made of phosphor bronze, stainless steel, or the like has been used to satisfactorily apply a frictional charge to a developer agent and further reduce the thickness of the developer agent staying on the developing roller. Incidentally, Japanese Patent Application Laid-open No. 2002-372858 discloses the related art.

However, the above-described configuration in the prior art raises the following problems.

FIG. 4A is a view schematically showing the configuration of a restricting blade 40c and a developing roller 40a. As shown in FIG. 4A, the restricting blade 40c counterclockwise is brought into contact with the surface of the developing roller 40a, and thus, restricts the thickness of a developer agent at an edge of the tip thereof.

FIG. 4B is an enlarged view of a tip after punching a metallic plate. When the metallic plate is punched, a “round face” having a curve, a “sheared face,” a “broken face,” and a “burr” are formed at the tip in this order in a punch direction. The above-described restricting blade is brought into contact with the surface of the developing roller 40a in the state in which the upper surface in FIG. 4B is referred to as a “contact surface,” thereby achieving the restriction of the thickness of the developer agent staying on the developing roller 40a.

FIG. 4C is a view schematically showing the above-described restricting blade 40c which restricts the thickness of the developer agent staying on the developing roller 40a. The shapes of the sheared face and the broken face are not always constant at the tip of the restricting blade 40c obtained by punching, and therefore, they become non-uniform along the longitudinal direction of the restricting blade 40c (i.e., the axial direction of the developing roller 40a) (variations in shape of the tip). In this case, for example, the flow of the developer agent at a portion where the sheared face projects toward a back face opposite to the contact surface is different from those at other portions, and therefore, the developer agent is liable to be reserved thereat. As a consequence, the thickness of the developer agent is increased, thereby raising a problem of occurrence of a streak on an image. FIG. 4C shows the case where a portion a having the height from an extension line of the back face to the sheared face (i.e., the height of the sheared face) is locally varied.

### SUMMARY OF THE INVENTION

An object of the present invention is to provide a restricting blade obtained by punching a metallic plate, the restricting blade being capable of uniformly restricting the thickness of a developer agent so as to prevent any occurrence of streaks on an image, and a developing device.

In order to achieve the above-described object, a restricting blade for restricting the thickness of a developer agent borne on a developing roller in contact with the developing roller includes: a metallic plate subjected to punching; a contact surface perpendicular to a thickness direction of the metallic plate, the surface being positioned upstream in a punch direction and brought into contact with the developing roller; an end surface of the metallic plate, formed by the punching, the surface being positioned at the metallic plate upstream in a rotational direction of the developing roller; and a coating layer formed in such a manner as to cover the end surface and a surface on the side of the end surface, positioned opposite to the contact surface in the thickness direction of the metallic plate with a resin or an elastomer.

In order to achieve the above-described object, a developing device includes: a developing roller for developing an electrostatic latent image with a developer agent borne thereon; and a restricting blade for restricting the thickness of the developer agent borne on the developing roller in contact with the developing roller, wherein the restricting blade includes: a metallic plate subjected to punching; a contact surface perpendicular to a thickness direction of the metallic plate, the surface being positioned upstream in a punch direction and brought into contact with the developing roller; an end surface of the metallic plate, formed by the punching, the surface being positioned at the metallic plate upstream in a rotational direction of the developing roller; and a coating layer formed in such a manner as to cover the end surface and a surface on the side of the end surface, positioned opposite to the contact surface in the thickness direction of the metallic plate with a resin.

### BRIEF DESCRIPTION OF THE DRAWINGS

FIGS. 1A and 1B are views schematically showing the configuration of an image forming apparatus and a developing device, respectively, in a preferred embodiment;

FIGS. 2A and 2B are views schematically showing the configuration of a restricting blade in the preferred embodiment;

FIG. 3 is a explanatory view of a fabricating method for the restricting blade in the preferred embodiment; and

FIGS. 4A, 4B, and 4C are views schematically showing the configuration of a restricting blade in the prior art.

### DESCRIPTION OF THE EMBODIMENTS

A detailed description will be illustratively given below of preferred embodiments for embodying the present invention with reference to the attached drawings. Here, the dimensions, materials, shapes, and relative arrangement of component parts described in the preferred embodiments shall not limit the scope of the invention to the embodiments, as long as not specifically stated.

### 1: Schematic Configuration of Image Forming Apparatus

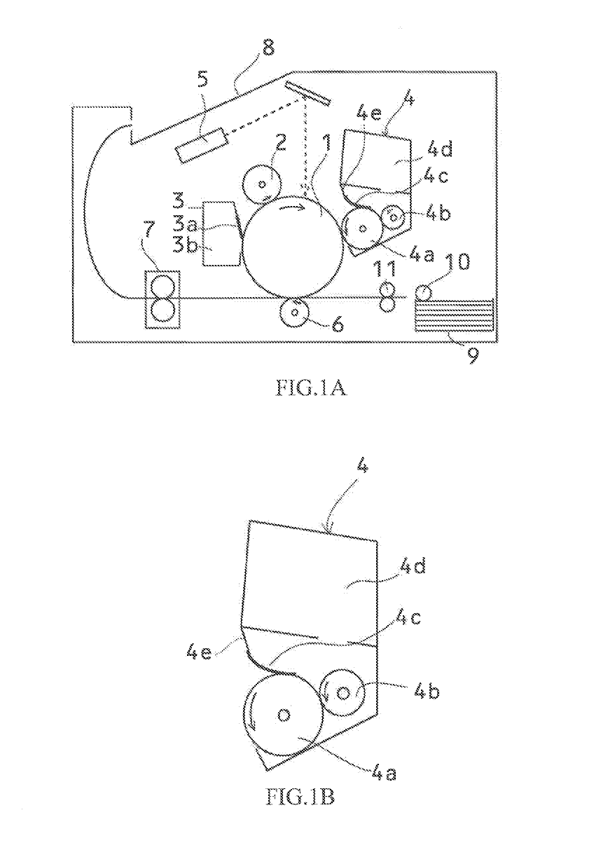

Referring to FIGS. 1A and 1B, explanation will be made on an image forming apparatus, to which a developing device in a preferred embodiment is applicable. FIG. 1A is a view schematically showing the configuration of the image forming apparatus, to which the developing device in the present preferred embodiment is applicable.

The image forming apparatus is a laser beam printer of an electrophotographic system, including a photosensitive drum 1 (i.e., an image carrier) which can be rotated in a direction indicated by an arrow in FIG. 1A by a drive source, not shown. Around the photosensitive drum 1 are arranged a charging roller 2, a developing device 4, a transferring roller 6, and a cleaner 3 in this order along the rotational direction of the photosensitive drum 1. In addition, above the photosensitive drum 1 is installed an exposing device 5 for scanning and exposing the surface of the photosensitive drum 1 with and to a laser beam.

With this configuration, when a charging voltage is applied to the charging roller 2, the surface of the photosensitive drum 1 is uniformly charged to the same polarity as that of a developer agent. When the exposing device 5 scans and exposes the charged surface with and to the laser beam, an electrostatic latent image is formed on the photosensitive drum 1. Thereafter, the developing device 4 supplies the developer agent to the electrostatic latent image, thereby developing the electrostatic latent image as a developer agent image. The developer agent image developed in this manner is transferred onto a sheet material at a transfer nip defined between the photosensitive drum 1 and the transferring roller 6. The sheet material having the developer agent image transferred thereonto is transported to a fixing device 7. The sheet material, to which the developer agent image is heated and fixed in the fixing device 7, is discharged to a discharge unit 8 disposed at the upper portion of an apparatus body. A plurality of sheet materials can be stacked on a sheet cassette 9. Upon start of image formation, the sheet materials are transported one by one to the transfer nip through a feed roller 10 and a pair of transportation rollers 11 from the sheet cassette 9 while counting a timing.

After the developer agent image is transferred, the developer agent which has not transferred onto the sheet material remains on the photosensitive drum 1. In view of this, the cleaner 3 is provided in the image forming apparatus, for removing the remaining developer agent from the surface of the photosensitive drum 1. The cleaner 3 includes a cleaning blade 3a obtained by forming urethane rubber or silicon rubber into a blade shape and a cleaning container 3b. Here, the tip edge of the cleaning blade 3a is brought into contact with the surface of the photosensitive drum 1. With the above-described configuration, the cleaning blade 3a is counterclockwise brought into contact with the surface of the photosensitive drum 1 being rotated, so that the developer agent can be scraped off from the surface of the photosensitive drum 1 at the tip edge of the cleaning blade 3a. Furthermore, the scraped developer agent is contained in the cleaning container 3b.

The configuration of the image forming apparatus, to which the developing device 4 in the present preferred embodiment is applicable, is not limited to the above-described configuration. Specifically, an intermediate transfer system may be adopted in which after the developer agent image may be primarily transferred onto an intermediate transfer belt from the surface of the photosensitive drum 1, it may be secondarily transferred onto the sheet material; or, a transportation belt system may be adopted in which the sheet material is electrostatically adsorbed onto a transportation belt, and then, it is transported to the transfer nip. Alternatively, the developing device 4 may be configured to be detachably attached with respect to the apparatus body of the image forming apparatus, or the developing device 4, the charging roller 2, and the cleaner 3 may be held integrally with each other in a process cartridge.

### 2: Schematic Configuration of Developing Device

Referring to FIG. 1B, explanation will be made on the schematic configuration of the developing device 4. FIG. 1B is a view schematically showing the configuration of the developing device 4 in the present preferred embodiment. The developing device 4 in the present preferred embodiment is of a nonmagnetic one-component contact development system, in which a negative charged developer agent of a nonmagnetic one-component is contained.

The developing device 4 includes a cylindrical developing roller 4a for supplying the developer agent onto the photosensitive drum 1 in contact with the surface of the photosensitive drum 1 and a supply roller 4b for supplying the developer agent onto the developing roller 4a in contact with the surface of the developing roller 4a. The developing roller 4a is exposed to the entire region in a direction of a rotary shaft of the photosensitive drum 1 from an opening formed at a frame of the developing device 4, and is brought into contact with the surface of the photosensitive drum 1 under a predetermined contact pressure. Moreover, the developing device 4 includes a restricting blade 4c which is brought into face contact with the surface of the developing roller 4a in such a manner that its longitudinal direction is substantially parallel to the axial direction of the developing roller 4a, for restricting the thickness of the developer agent to be supplied onto the developing roller 4a.

The developing roller 4a is configured such that a development voltage can be applied thereto from a power source, not shown. A predetermined DC voltage as the development voltage is applied, thus electrostatically supplying the developer agent onto the photosensitive drum 1 from the surface of the developing roller 4a. The developer agent supply roller 4b is an elastic roller made of urethane sponge or the like, and is provided in a rotatable manner in the same direction as that of the developing roller 4a. With this configuration, the developer agent contained in a developer agent container 4d can be supplied from the surface of the developer agent supply roller 4b to the surface of the developing roller 4a. Here, the developer agent which has not been supplied to the surface of the photosensitive drum 1 but remains on the developing roller 4a can be scraped off by the developer agent supply roller 4b.

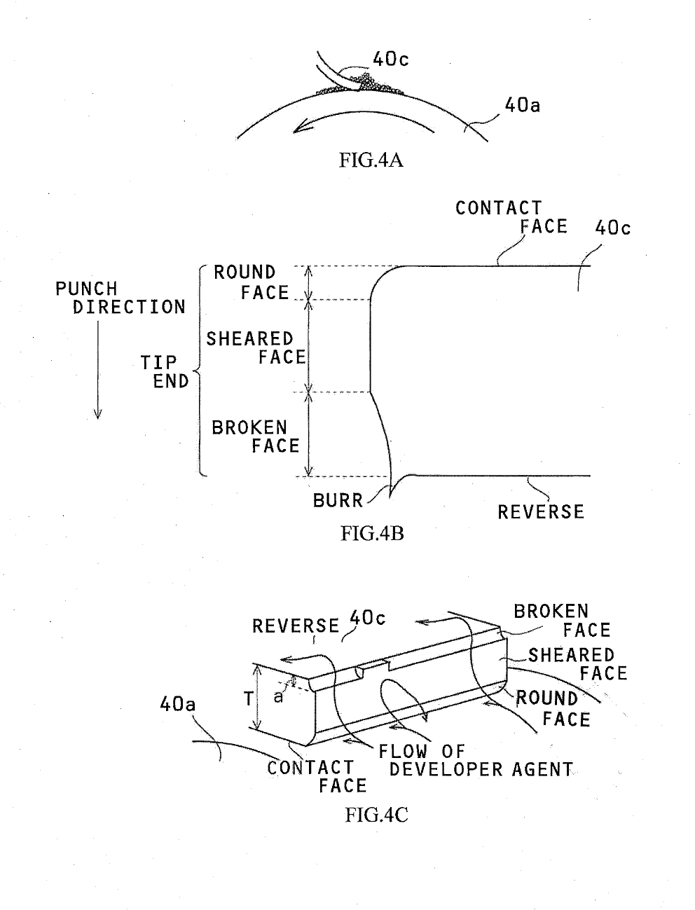

A metallic blade obtained by “punching,” that is, punching a metallic plate is used as the restricting blade 4c (the shape of the tip surface after the punching is the same as that shown in FIGS. 4A to 4C). The restricting blade 4c is obtained by punching which is relatively inexpensive machining, and therefore, the fabrication costs of the restricting blade 4c, and further, the developing device 4 and the image forming apparatus can be suppressed. The metallic plates include plates made of phosphor bronze, stainless steel, aluminum, spring steel, and the like whose surface may be subjected to application with chromate, a lubricating resin, or the like. The thickness of the restricting blade 4c should be preferably 0.05 mm or more and 0.15 mm or less. If the thickness is 0.05 mm or more, the restricting blade 4c can be brought into contact with the surface of the developing roller 4a under a proper contact pressure, thereby securely restricting the thickness of the developing agent. In contrast, if the thickness is 0.15 mm or less, the restricting blade 4c can securely follow the surface of the developing roller 4a by its elasticity, thereby securely restricting the thickness of the developing agent.

The restricting blade 4c is fixed to a support member 4e disposed at one end thereof in the frame of the developing device 4 in such a manner as to follow the rotation of the developing roller 4a. Moreover, the restricting blade 4c is brought into contact with the surface of the developing roller 4a while a surface opposite to that in a direction in which the punching is performed, that is, the surface at which the “round face” explained with reference to FIGS. 4A to 4C is formed, is referred to a “contact surface.” Furthermore, the end formed by punching (i.e., the end through which a punch passes in punching) is referred to as a “tip surface” oriented upstream in the rotational direction of the developing roller 4a. In other words, the tip surface serves as a free end of the restricting blade 4c. Here, a surface of the restricting blade 4c out of contact with the surface of the developing roller 4a opposite to the contact surface, that is, the reverse of the metallic plate in punching will be hereinafter referred to as a “reverse” of the restricting blade 4c.

Additionally, in the present preferred embodiment, the restricting blade 4c is connected to a power source, not shown. A voltage of the same polarity as that of an electric charge of a developer agent is applied to the restricting blade 4c, so that a satisfactory friction charge can be applied to the developer agent. As a consequence, it is possible to enhance the development performance of the developing device 4, and further, to prevent the developer agent from being fused to the restricting blade 4c. Incidentally, the material for the support member 4e for supporting the restricting blade 4c is not particularly limited, and therefore, it may be selected from metal, ceramic, a resin, and the like.

### 3: Coating Layer for Restricting Blade

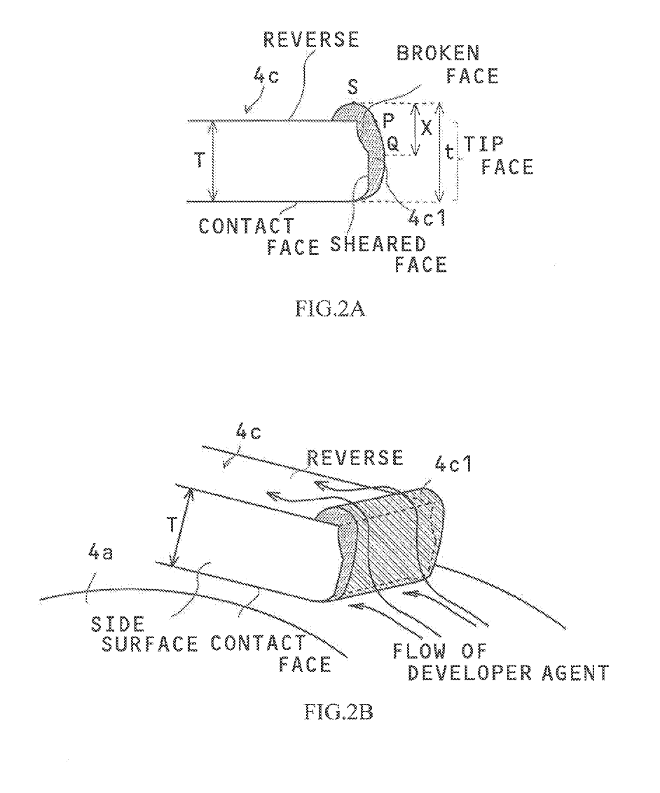

Referring to FIGS. 2A and 2B, a description will be given of a coating layer 4c1 formed at the restricting blade 4c in the present preferred embodiment. FIG. 2A is a cross-sectional view schematically showing the restricting blade 4c, as viewed in cross section perpendicular to a longitudinal direction; and FIG. 2B is a view showing the restricting blade 4c which restricts the thickness of the developer agent at the surface of the developing roller 4a.

The restricting blade 4c in the present preferred embodiment is featured in that its tip surface formed by punching and at least a region in the vicinity of the tip surface at the reverse are covered with the coating layer 4c1. In FIG. 2A, the coating layer 4c1 is shaded. The material for the coating layer 4c1 may be desirably a resin or an elastomer. Specifically, it may be selected from polyamide, a polyamide elastomer, polyester, a polyester elastomer, polyester terephthalate, polyurethane, silicon rubber, a silicon resin, a melanin resin, and the like singly or in combination of two or more. In addition, a conductive material or coarse particles may be added to the above-described material. The appropriate selection of the material according to the kind or particle size of the developer agent can prevent any variations in shape of the tip surface of the restricting blade 4c, and further, the developer agent from adhering to or remaining at the tip surface of the restricting blade 4c.

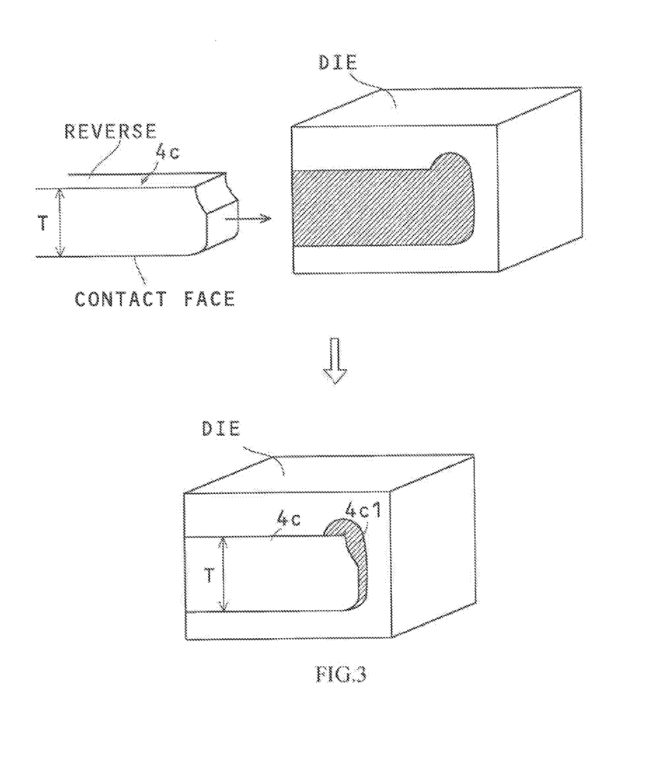

In the present preferred embodiment, the above-described coating layer 4c1 is formed by “injection molding.” FIG. 3 illustrates a method for molding the coating layer 4c1. In forming the coating layer 4c1, the metallic plate formed by punching is fed to a die for injection molding, followed by swaging. Here, it is desirable that an adhesive layer should be previously applied to the surface to be coated of the restricting blade 4c, and the coated surface should be protected immediately before the restricting blade 4c is fed to the die. Since the adhesive layer is formed, the coating layer 4c1 can be firmly welded to the metallic plate, thereby enhancing the durability of the restricting blade 4c. Incidentally, the material for the adhesive layer may be selected from, for example, hot melt based materials such as polyurethane, polyester, ethylenevinyl alcohol, and polyamide.

In the state in which the restricting blade 4c is fed to the die and the die is swaged, clearances (i.e., metallic cavities) are formed between the tip surface and reverse of the restricting blade 4c and the die. The molten resin or elastomer is injected into the clearances, followed by cooling, so that the coating layer 4c1 can be formed at the tip of the restricting blade 4c and at least the region in the vicinity of the tip surface of the reverse. As shown in FIG. 2A, the coating layer 4c1 is formed in the restricting blade 4c such fabricated as described above in such a manner as to uniformly cover the sheared face and the broken face, and therefore, the shape of the tip surface of the restricting blade 4c can be made uniform in the longitudinal direction of the restricting blade 4c. In other words, the outer shape of the coating layer 4c1 at the cross section perpendicular to the longitudinal direction of the restricting blade 4c is uniform in all of the cross sections perpendicular to the longitudinal direction, thereby eliminating the variations in shape at the tip surface. Incidentally, although the explanation has been made on the “injection molding,” the coating layer 4c1 may be formed by “extrusion molding.”

When the thickness of the developer agent is restricted at the surface of the developing roller 4a by using the above-described restricting blade 4c, the developer agent flows as shown in FIG. 2B. Specifically, since there is no variation in shape of the tip surface of the restricting blade 4c in the present preferred embodiment and the shape of the tip surface is made substantially uniform in the longitudinal direction, the developer agent substantially uniformly flows at any positions in the longitudinal direction of the restricting blade 9c. Thus, the problem of occurrence of streaks at a specified position on an image cannot be raised, thereby enhancing the quality of an image.

### 4: Dimension and Arithmetic Mean Roughness of Coating Layer

Referring to FIG. 2A, explanation will be made on the dimension and arithmetic mean roughness of the coating layer 4c1 described above. Dimensions below may be freely varied by adjusting the dimension of the die for use in the injection molding. Any of the dimensions below influences on the flow of the developer agent at the surface of the developing roller 4a. In particular, it is found that a “distance X (μm)” and a “maximum thickness t (μm)” are important parameters which determine the flow of the developer agent.

<Thickness of Coating Layer (μm)>

The thickness of the coating layer should be preferably 10 μm or more and 1000 μm or less. More preferably, it should be 20 μm or more and 1000 μm or less. If it is 20 μm or more, the sheared face can be securely covered even at a portion at which the sheared face projects in the direction of the reverse, and further, even if a “burr” remains at the reverse, the “burr” can be securely covered with the coating layer 4c1. Consequently, the shape of the tip surface of the restricting blade 4c can be made uniform. In contrast, if the thickness is 1000 μm or less, the thickness of the developer agent can be stably restricted at the surface of the developing roller 4a.

<Distance X (μm)>

As shown in FIG. 2A, a portion of the coating layer 4c1 projecting most in the direction of the normal to the reverse, that is, a portion remotest from the contact surface in the thickness direction is denoted by S. In the meantime, a portion of the coating layer 4c1 most projecting toward the tip in the direction perpendicular to the normal, that is, a most upstream portion in the rotational direction of the developing roller in the direction perpendicular to the thickness direction is designated by Q. The distance between the portion S and the portion Q to in the direction perpendicular to the reverse (i.e., the thickness direction) is denoted by X (μm). Here, the distance X (μm) within the same cross section was measured at a measurement magnification of 1000 (objective 50×20) by a super depth color 3D shape microscope (VK-9500 manufactured by Keyence Corporation). Moreover, the distance X was measured on the plurality of cross sections in the entire region in the longitudinal direction of the restricting blade 4c at a measurement pitch of 0.05 μm. At that time, a difference between the maximum and the minimum of X is designated by ΔX.

<Maximum Thickness (Maximum Length) t (μm)>

As shown in FIG. 2A, the maximum length in the direction perpendicular to the reverse in the coating layer 4c1 (i.e., the thickness direction) is denoted by t (μm). In other words, the maximum length t is also referred to as an interval between the contact surface and the portion S most projecting in the direction of the normal to the reverse in the coating layer 4c1. Similarly to the above-described distance X, the maximum length t (μm) was measured at a measurement magnification of 1000 (objective 50×20) by the super depth color 3D shape microscope (VK-9500 manufactured by Keyence Corporation).

### <ΔX/t>

As the value ΔX/t is smaller, the shape variation at the tip surface of the restricting blade 4c becomes smaller. That is to say, the thickness of the developer agent can be uniformly restricted without any occurrence of a streak on an image, thus achieving the high quality of an image. The earnest study by the inventors of the present invention revealed that when the value ΔX/t is ⅛ or less (ΔX≦t/8) the flow of the developer agent need not be varied in the coating layer 4c1, so that there is least possibility that a streak occurs on an image. In other words, as long as this condition is satisfied, it is construed that the tip surface of the restricting blade 4c is smooth.

<Arithmetic Mean Roughness Ra (μm)>

In the present preferred embodiment, an arithmetic mean roughness Ra (μm) at the position P in FIG. 2A was measured. Specifically, an arithmetic mean roughness Ra (μm) on an intersection between the extension line of the reverse and the surface of the coating layer 4c1 was measured. When the arithmetic mean roughness Ra (μm) at the position is large, the flow of the developer agent may be possibly varied on the coating layer 4c1. The earnest study by the present inventors has revealed that when the arithmetic mean roughness Ra (μm) at the position P is 0.3 μm or less, the flow of the developer agent need not be varied on the coating layer 4c1, thereby reducing the possibility of occurrence of a streak on an image. In other words, as long as the condition is satisfied, it is construed that the tip surface of the restricting blade 4c is smooth. Incidentally, the arithmetic mean roughness Ra (μm) is defined under JIS B 0601-1994. The arithmetic mean roughness Ra (μm) was measured by the super depth color 3D shape microscope (VK-9500 manufactured by Keyence Corporation). The measurement was made under the conditions of a measurement magnification of 1000 (objective 50×20), a measurement length of 0.25 mm (the measurement direction being a longitudinal direction of the restricting blade 4c), a cut-off wavelength of 0.08 mm, and a measurement pitch of 0.05 μm. The average of values at five points at the position P in the longitudinal direction was taken as the arithmetic mean roughness Ra (μm).

### 5: Preferred Embodiments

The preferred embodiments will be described by way of examples in the case where the dimension and arithmetic mean roughness of the above-described coating layer 4c1 are varied.

### Example 1

In the present example, a stainless steel plate having a thickness T of 0.08 mm was used as the metallic plate. The difference ΔX of the above-described “distance X (μm)” was 75 μm, the “maximum thickness t (μm)” was 600 μm, and the “arithmetic mean roughness Ra (μm)” was 0.3 μm. With these dimensions, ΔX=t/8. The coating layer 4c1 was formed at the tip surface and at least in the vicinity of the tip surface of the reverse of the restricting blade 4c by welding and injecting a polyamide elastomer (Trade name: Diamide E40), which was formed at a die temperature of 40° C., at a temperature from 200° C. to 270° C., followed by cooling.

### Example 2

In the present example, a stainless steel plate having a thickness T of 0.08 mm was used as the metallic plate. The difference ΔX of the above-described “distance X (μm)” was 15 μm, the “maximum thickness t (μm)” was 300 μm, and the “arithmetic mean roughness Ra (μm)” was 0.5 μm. With these dimensions, ΔX=t/20. Here, the coating layer 4c1 was formed in the same manner as Example 1.

### Example 3

In the present example, a stainless steel plate having a thickness T of 0.08 mm was used as the metallic plate. The difference ΔX of the above-described “distance X (μm)” was 50 μm, the “maximum thickness t (μm)” was 300 μm, and the “arithmetic mean roughness Ra (μm)” was 0.3 μm. With these dimensions, ΔX=t/6. Here, the coating layer 4c1 was formed in the same manner as Example 1.

### Example 4

In the present example, the restricting blade 4c was formed by extrusion molding in a manner different from Examples 1 to 3. Specifically, a stainless steel plate having a thickness T of 0.08 mm was put into a die, and then, a polyimide elastomer was dissolved at a temperature from 200° C. to 270° C., followed by sequentially injecting into a die cavity while traveling with the restricting blade 4c inside of an extrusion molder, thereby obtaining the coating layer 4c1. Here, the difference ΔX of the above-described “distance X (μm)” was 10 μm, the “maximum thickness t (μm)” was 100 μm, and the “arithmetic mean roughness Ra (μm)” was 0.3 μm. With these dimensions, ΔX=t/10.

### Example 5

In the present example, a stainless steel plate having a thickness T of 0.15 mm was used as the metallic plate. The difference ΔX of the above-described “distance X (μm)” was 100 μm, the “maximum thickness t (μm)” was 1000 μm, and the “arithmetic mean roughness Ra (μm)” was 0.3 μm. With these dimensions, ΔX=t/10. The coating layer 4c1 was formed by injection-molding a polyester elastomer in the present example.

### 6: Result of Comparison with Comparative Examples

In order to verify the effects of the present preferred embodiment, the thickness of the developer agent was restricted by using the restricting blades 4c in Examples 1 to 5 described above and restricting blades in Comparative Examples 1 to 4 below, and then, the occurrence of a streak on an image and the restriction degree of the developer agent were examined in each of Examples. Hereinafter, explanation will be made on the conditions of Comparative Examples 1 to 4 and the comparison result.

### Comparative Example 1

In this comparative example, the developer agent was restricted by using a conventional restricting blade without the above-described coating layer. In the same manner as in Examples 1 to 4, a stainless steel plate having a thickness T of 0.08 mm was used as a metallic plate. The numerical values of the “distance X,” the “maximum length t,” and the “arithmetic mean roughness Ra” were those of the metallic plate. Here, the difference ΔX of the above-described “distance X” was 20 μm, the “maximum thickness t” was 80 μm, and the “arithmetic mean roughness Ra” was 0.5 μm. With these dimensions, ΔX=t/4.

### Comparative Example 2

In this comparative example, the developer agent was restricted by using a conventional restricting blade without the above-described coating layer. In the same manner as in Examples 1 to 4, a stainless steel plate having a thickness T of 0.08 mm was used as a metallic plate. The numerical values of the “distance X,” the “maximum length t,” and the “arithmetic mean roughness Ra” were those of the metallic plate. Here, the difference ΔX of the above-described “distance X” was 20 the “maximum thickness t” was 80 μm, and the “arithmetic mean roughness Ra” was 0.4 μm. With these dimensions, ΔX=t/4.

### Comparative Example 3

In this comparative example, the same metallic plate as that in Example 1 was used, and further, the same material was subjected to injection-molding, thereby forming the coating layer. The difference ΔX of the above-described “distance X” was 200 μm, the “maximum thickness t” was 600 μm, and the “arithmetic mean roughness Ra” was 1.0 μm. With these dimensions, ΔX=t/3.

### Comparative Example 4

In this comparative example, a stainless steel plate having a thickness T of 0.15 mm was used as a metallic plate. A coating layer was formed by the injection-molding in the same manner as Comparative Example 3. The difference ΔX of the above-described “distance X” was 200 μm, the “maximum thickness t” was 2000 μm, and the “arithmetic mean roughness Ra” was 0.3 μm. With these dimensions, ΔX=t/10.

The evaluation result is shown below in Table 1.

TABLE 1

| | | MATERIAL FOR | DIMENSION AND ARITHMETIC | | | | IMAGE | | |
|---|---|---|---|---|---|---|---|---|---|
| | THICKNESS OF | COATING | MEAN ROUGHNESS | | | | STREAK | STREAK | RESTRICTION |
| | METALLIC PLATE | LAYER | ΔX (μm) | t (μm) | ΔX/t | Ra (μm) | (BEGINING) | (END) | DEGREE |
| EXAMPLE 1 | STAINLESS | POLYAMID | 75 | 600 | 1/8 | 0.3 | ◯ | ◯ | ◯ |
| | STEEL | ELASTOMER | | | | | | | |
| | 0.08 μm | | | | | | | | |
| EXAMPLE 2 | STAINLESS | POLYAMID | 15 | 300 | 1/20 | 0.5 | ◯ | ◯ | ◯ |
| | STEEL | ELASTOMER | | | | | | | |
| | 0.08 μm | | | | | | | | |
| EXAMPLE 3 | STAINLESS | POLYAMID | 50 | 300 | 1/6 | 0.3 | ◯ | ◯ | ◯ |
| | STEEL | ELASTOMER | | | | | | | |
| | 0.08 μm | | | | | | | | |
| EXAMPLE 4 | STAINLESS | POLYAMID | 10 | 100 | 1/10 | 0.3 | ◯ | ◯ | ◯ |
| | STEEL | ELASTOMER | | | | | | | |
| | 0.08 μm | | | | | | | | |
| EXAMPLE 5 | STAINLESS | POLYESTER | 100 | 1000 | 1/10 | 0.3 | ◯ | ◯ | ◯ |
| | STEEL | ELASTOMER | | | | | | | |
| | 0.15 μm | | | | | | | | |
| COMPARATIVE | STAINLESS | — | 20 () | 80 () | 1/4 () | 0.5 () | X | X | ◯ |
| EXAMPLE 1 | STEEL | | | | | | | | |
| | 0.08 μm | | | | | | | | |
| COMPARATIVE | STAINLESS | — | 20 () | 80 () | 1/4 () | 0.4 () | Δ | X | ◯ |
| EXAMPLE 2 | STEEL | | | | | | | | |
| | 0.08 μm | | | | | | | | |
| COMPARATIVE | STAINLESS | POLYAMID | 200 | 600 | 1/3 | 1.0 | X | X | ◯ |
| EXAMPLE 3 | STEEL | ELASTOMER | | | | | | | |
| | 0.08 μm | | | | | | | | |
| COMPARATIVE | STAINLESS | POLYAMID | 200 | 2000 | 1/10 | 0.3 | ◯ | — | X |
| EXAMPLE 4 | STEEL | ELASTOMER | | | | | | | |
| | 0.15 μm | | | | | | | | |

As is found from Table 1, Examples 1, 2, 4, and 5 satisfy that ΔX/t is ⅛ or less (i.e., ΔX≦t/8). Therefore, the restricting blade could uniformly restrict the developer agent on the developing roller 4a from the beginning of image formation till exhaustion, thereby producing no streak on an image. Incidentally, in Example 3, ΔX/t is larger than ⅛. However, the arithmetic mean roughness Ra (μm) is 0.3 or less (the same in Examples 1, 4, and 5). This means the formation of the smooth coating layer 4c1, and therefore, no streak occurs on an image from the beginning of image formation till exhaustion.

To the contrary, no coating layer is formed in Comparative Examples 1 and 2 in the same manner as conventional. As a consequence, the shape is varied at the tip surface of the restricting blade in the longitudinal direction (it is found from the large value of ΔX/t), and therefore, a steak occurs on an image from the beginning of image formation till exhaustion. In contrast, although the coating layer was formed in Comparative Example 3, ΔX/t is larger than ⅛ and the arithmetic mean roughness Ra (μm) is larger than 0.3, and therefore, a steak occurs on an image. Moreover, although the coating layer was formed with ΔX/t being ⅛ or less and the arithmetic mean roughness Ra (μm) being 0.3 or less in Comparative Example 4, the maximum thickness t (μm) of the tip surface is large, and therefore, the contact pressure between the restricting blade and the surface of the developing roller locally becomes large. As a consequence, although no streak occurs on an image, deficiency occurs in restriction of the developer agent.

As described above, the present preferred embodiment can provide the restricting blade obtained by punching the metallic plate, capable of uniformly restricting the thickness of the developer agent so as to prevent any occurrence of a streak on, an image, and the developing device using the same.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-292604, filed on Dec. 24, 2009, which is hereby incorporated by reference herein in their entirety.

1. A restricting blade for restricting the thickness of a developer agent borne on a developing roller in contact with the developing roller, the restricting blade comprising:
a metallic plate subjected to punching;
a contact surface perpendicular to a thickness direction of the metallic plate, the contact surface being positioned upstream in a punch direction and brought, into contact with the developing roller;
an end surface of the metallic plate, formed by the punching, the end surface being positioned at the metallic plate upstream in a rotational direction of the developing roller; and
a coating layer formed in such a manner as to cover the end surface and a part of a surface on the side of the end surface, positioned opposite to the contact surface in the thickness direction of the metallic plate with a resin or an elastomer.

2. The restricting blade according to claim 1, wherein the coating layer is formed by injection molding or extrusion molding.

3. The restricting blade according to claim 1, wherein when the coating layer is viewed in a cross section perpendicular to a longitudinal direction of the restricting blade, the following relationship is satisfied:
ΔX≦t/8
wherein when S represents a portion remotest from the contact surface in the thickness direction of the coating layer, Q represents a most upstream portion in the rotational direction of the developing roller in the direction perpendicular to the thickness direction of the coating layer, and X represents a distance between the portion S and the portion Q in the thickness direction, ΔX represents a difference between a maximum and a minimum in measuring the distances X of the plurality of different cross sections in the longitudinal direction of the restricting blade and t represents a greatest length in the thickness direction of the coating layer.

4. The restricting blade according to claim 1, wherein an arithmetic average roughness Ra (μm) on an intersection of a surface of the coating layer and an extension surface of a surface positioned opposite to the contact surface in the thickness direction of the metallic plate at the surface of the coating layer is 0.3 μm or less.

5. A developing device comprising:
a developing roller for developing an electrostatic latent image with a developer agent borne thereon; and
a restricting blade for restricting the thickness of the developer agent borne on the developing roller in contact with the developing roller, wherein the restricting blade includes:
a metallic plate subjected to punching;
a contact surface perpendicular to a thickness direction of the metallic plate, the contact surface being positioned upstream in a punch direction and brought into contact with the developing roller;
an end surface of the metallic plate, formed by the punching, the end surface being positioned at the metallic plate upstream in a rotational direction of the developing roller; and
a coating layer formed in such a manner as to cover the end surface and a part of a surface on the side of the end surface, positioned opposite to the contact surface in the thickness direction of the metallic plate with a resin.

6. The developing device according to claim 5, wherein the coating layer is formed by injection molding or extrusion.

7. The developing device according to claim 5, wherein when the coating layer is viewed in a cross section perpendicular to a longitudinal direction of the restricting blade, the following relationship is satisfied:
ΔX≦t/8
wherein when S represents a portion remotest from the contact surface in the thickness direction of the coating layer, Q represents a most upstream portion in the rotational direction of the developing roller in the direction perpendicular to the thickness direction of the coating layer, and X represents a distance between the portion S and the portion Q in the thickness direction, ΔX represents a difference between a maximum and a minimum in measuring the distances X of the plurality of different cross sections in the longitudinal direction of the restricting blade and t represents a greatest length in the thickness direction of the coating layer.

8. The developing device according to claim 5, wherein an arithmetic average roughness Ra (μm) on an intersection of a surface of the coating layer and an extension surface of a surface positioned opposite to the contact surface in the thickness direction of the metallic plate at the surface of the coating layer is 0.3 μm or less.
